(19) United States
(12) Patent Application Publication
(10) Pub. No.: US 2016/0004853 A1
(43) Pub. Date: Jan. 7, 2016

(54) PREVENTING UNAUTHORIZED ACCESS TO COMPUTER SOFTWARE APPLICATIONS

(71) Applicant: International Business Machines Corporation, Armonk, NY (US)

(72) Inventors: Mickey Boodaei, Givatayim (IL); Yaron Dycian, Kadima (IL); Shmuel Regev, Tel Aviv (IL)

(21) Appl. No.: 14/324,381

(22) Filed: Jul. 7, 2014

(51) Int. Cl. G06F 21/31

(52) U.S. Cl. CPC G06F 21/316

(57) ABSTRACT

Preventing unauthorized access to computer software applications by receiving keyboard event information corresponding to a plurality of keyboard events detected at a computer, wherein the keyboard events represent input to a computer software application, determining that a number of paste actions indicated by the keyboard event information equals or exceeds a predefined threshold, and performing a computer-security-related action responsive to determining that the number of paste actions equals or exceeds the predefined threshold, wherein the computer-security-related action relates to the computer software application.

### BACKGROUND

The present invention relates generally to computer software applications, and more particularly to preventing unauthorized access to computer software applications.

Unauthorized use of computer software applications, such as online banking applications, frequently involves a perpetrator gaining access to an application by providing the application with the valid credentials of an authorized user, such as where the perpetrator obtained the credentials through theft or subterfuge.

### SUMMARY

In one aspect of the invention a method is provided for preventing unauthorized access to computer software applications, the method including receiving keyboard event information corresponding to a plurality of keyboard events detected at a computer, wherein the keyboard events represent input to a computer software application, determining that a number of paste actions indicated by the keyboard event information equals or exceeds a predefined threshold, and performing a computer-security-related action responsive to determining that the number of paste actions equals or exceeds the predefined threshold, wherein the computer-security-related action relates to the computer software application.

In other aspects of the invention systems and computer program products embodying the invention are provided.

### BRIEF DESCRIPTION OF THE DRAWINGS

Aspects of the invention will be understood and appreciated more fully from The following detailed description taken in conjunction with the appended drawings in which:

FIG. 1 is a simplified conceptual illustration of a system for preventing unauthorized access to computer software applications, constructed and operative in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

Embodiments of the invention may include a system, a method, and/or a computer program product. The computer program product may include a computer readable storage medium (or media) having computer readable program instructions thereon for causing a processor to carry out aspects of the invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, a segment, or a portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

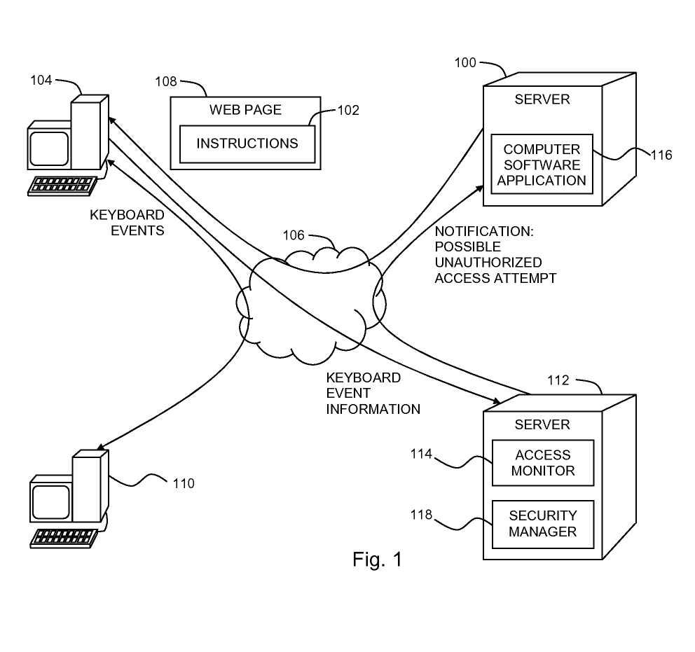

Reference is now made to FIG. 1 which is a simplified conceptual illustration of a system for detecting unauthorized access to computer software applications, constructed and operative in accordance with an embodiment of the invention. In the system of FIG. 1, a computer 100, hereinafter referred to as server 100, is configured to provide executable computer software instructions 102, hereinafter referred to as instructions 102, to a computer 104, hereinafter referred to as client 104, such as via a computer network 106, such as the Internet. Server 100 may, for example, provide instructions 102 in the form of JavaScript™ instructions that are embedded within a web page 108 that server 100 provides to client 104 as part of an attempt to access a computer software application at server 100, such as an online banking application. Server 100 may, in fact, represent multiple computers that each provide to client 104 different web pages and/or different portions of any given web page, and receive communications from client 104, but, for the sake of simplicity, is referred to herein as a single computer. Client 104 is configured to execute instructions 102 in accordance with conventional techniques.

Instructions 102 are configured, in accordance with conventional techniques, to detect keyboard events at client 104, such as where the keyboard events represent input into browser software and destined for a computer software application at server 100. Such keyboard events may correspond to keystrokes entered into a keyboard that is physically connected to client 104 or that is in proximate, wireless communication with client 104, such as using WiFi™ or Bluetooth™ communications protocols. Additionally or alternatively, such keyboard events may correspond to keystrokes entered into a keyboard at a computer other than client 104, such as at a computer 110, and transmitted as keyboard events to client 104 in accordance with remote computing techniques.

Instructions 102 are configured to determine when the keyboard events represent keystrokes being pasted rather than being typed. This may be accomplished, for example, where browser software at client 104 allows for instructions 102 to receive keyboard events that are themselves paste events. Alternatively, where browser software at client 104 is not configured to instructions 102 to provide keyboard events that are themselves paste events, instructions 102 may be configured to employ other techniques, such as by assuming that a paste event has occurred when data contained in normal keyboard events include both a character and a modifier key, or by monitoring changes to an input field, where if the length of the data entered into an input field grows by more than a single character as a result of a single keyboard event, the keyboard event is assumed to be a paste event.

Instructions 102 are also configured to report keyboard event information associated with keyboard events that are detected as described above, such as by reporting the keyboard event information as described herein to a server 112, or alternatively to server 100, where in the latter case references to server 112 herein may be understood as referring to server 100. The keyboard event information compiled by instructions 102 may simply include the keystrokes that the keyboard events represent, although instructions 102 are preferably configured to represent the keystrokes in the reported keyboard event information with substitute keystrokes, such as by mapping the keystrokes that the keyboard events represent to other keystroke values, such as where ‘A’ is mapped to ‘s’, in accordance with a predefined mapping scheme. Whichever reporting configuration is used, instructions 102 are configured to compile the keyboard event information such that keyboard events that are or include paste events are reported to server 112 such that they may be recognized as paste events at server 112 as described herein. Instructions 102 are also preferably configured to compile the keyboard event information for multiple keyboard events and report the keyboard event information periodically, such as at predefined intervals, and/or only when a web page form submission is detected. Keyboard events that are not related to paste events may be omitted from the keyboard event information.

Instructions 102 may optionally be configured to perform any of the operations described herein and provide their results as part of the keyboard event information.

An access monitor 114, which may be hosted by server 112, receives the keyboard event information reported by client 104 in accordance with instructions 102. Access monitor 114 is configured to determine whether a number of paste actions indicated by the keyboard event information equals or exceeds a predefined threshold, such as a threshold that is predefined in association with a computer software application 116 that is hosted by server 100, where the keyboard event information includes information regarding keyboard events detected at client 104 that represent input destined for computer software application 116. In an embodiment, the threshold is predefined by a system administrator of server 100.

A security manager 118 is configured to perform one or more computer-security-related actions if the number of paste actions equals or exceeds the predefined threshold. For example, one such computer-security-related action may be to prevent computer software application 116 from performing a transaction using the aforementioned input to computer software application 116. Additionally or alternatively, another such computer-security-related action may be to notify a system administrator of server 100 of a possible unauthorized attempt to access computer software application 116.

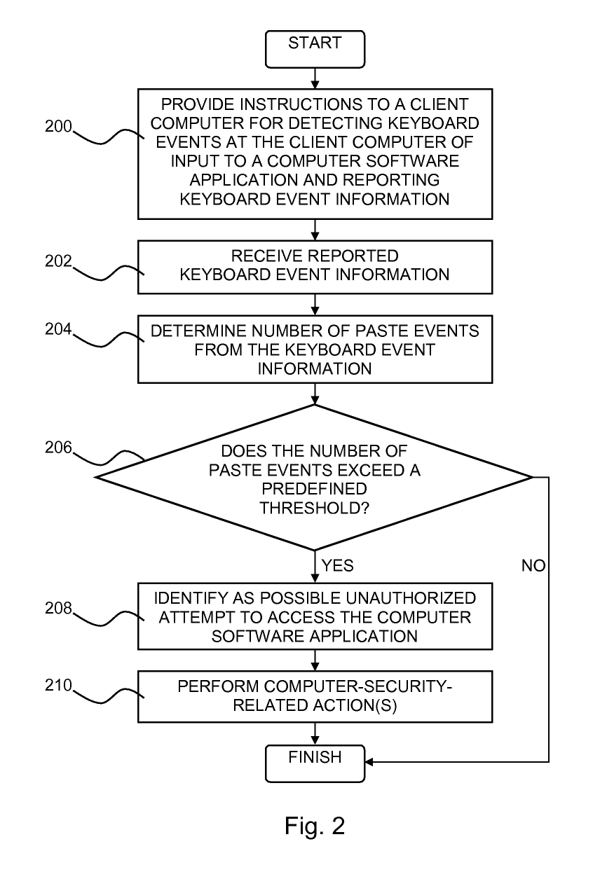

Reference is now made to FIG. 2 which is a simplified flowchart illustration of an exemplary method of operation of the system of FIG. 1, operative in accordance with an embodiment of the invention. In the method of FIG. 2, executable computer software instructions are provided to a client computer, where the instructions are configured as described hereinabove to detect keyboard events at the client computer that represent input to a computer software application and report keyboard event information associated with the keyboard events (step 200). The reported keyboard event information is received (step 202), from which information the number of keyboard paste events is determined (step 204). If the number of keyboard paste events does not exceed a predefined threshold (step 206), then instructions 102 ends processing. If the number of keyboard paste events equals or exceeds a predefined threshold (step 206), then a possible unauthorized attempt to access the computer software application is identified (step 208), whereupon one or more computer-security-related actions are performed (step 210), such as preventing the computer software application from performing a transaction using the input, and/or notifying a system administrator of the possible unauthorized attempt to access the computer software application.

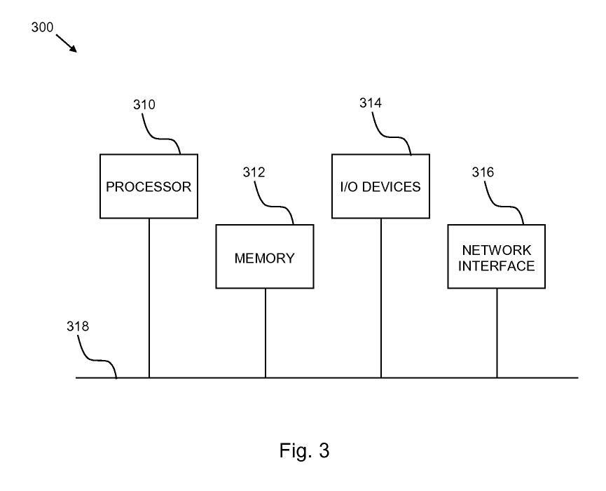

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), a flash memory, etc. Such memory may be considered a computer readable storage medium.

In addition, the phrase “input/output devices” or “I/O devices” as used herein is intended to include, for example, one or more input devices (e.g., a keyboard, a mouse, a scanner, etc.) for entering data to the processing unit, and/or one or more output devices (e.g., a speaker, a display, a printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for preventing unauthorized access to computer software applications, the method comprising:
receiving keyboard event information corresponding to a plurality of keyboard events detected at a computer, wherein the keyboard events represent input to a computer software application;
determining that a number of paste actions indicated by the keyboard event information exceeds a predefined threshold; and
performing a computer-security-related action responsive to determining that the number of paste actions equals or exceeds the predefined threshold, wherein the computer-security-related action relates to the computer software application.

2. The method of claim 1 and further comprising providing executable computer software instructions to the computer, wherein the executable computer software instructions are configured to:
monitor the keyboard events detected at the computer; and
report the keyboard event information associated with the keyboard events.

3. The method of claim 2 wherein the providing comprises providing the executable computer software instructions within a web page.

4. The method of claim 1 wherein the determining comprises determining wherein the predefined threshold is associated with the computer software application.

5. The method of claim 1 wherein the determining comprises determining the number of paste actions from the keyboard event information.

6. The method of claim 1 wherein the performing comprises preventing the computer software application from performing a transaction using the input to the computer software application.

7. The method of claim 1 wherein the receiving, determining, and performing are implemented in any of:
1. computer hardware; and
2. computer software embodied in a computer readable storage medium.

8. A system for preventing unauthorized access to computer software applications, the system comprising:
an access monitor configured to:
receive keyboard event information corresponding to a plurality of keyboard events detected at a computer, wherein the keyboard events represent input to a computer software application;
determine that a number of paste actions indicated by the keyboard event information equals or exceeds a predefined threshold; and
a security manager configured to perform a computer-security-related action responsive to determining that the number of paste actions equals or exceeds the predefined threshold, wherein the computer-security-related action relates to the computer software application.

9. The system of claim 8 wherein the computer is configured with executable computer software instructions that are configured to:
monitor the keyboard events detected at the computer; and
report the keyboard event information associated with the keyboard events.

10. The system of claim 9 wherein the executable computer software instructions are provided to the computer software within a web page.

11. The system of claim 8 wherein the predefined threshold is associated with the computer software application.

12. The system of claim 8 wherein the access monitor is configured to determine the number of paste actions from the keyboard event information.

13. The system of claim 8 wherein the executable computer software instructions are provided within a web page.

14. The system of claim 8 wherein the security manager is configured to prevent the computer software application from performing a transaction using the input to the computer software application.

15. The system of claim 8 wherein the access monitor and the security manager are implemented in any of:
a) computer hardware; and
b) computer software embodied in a computer readable storage medium.

16. A computer program product for preventing unauthorized access to computer software applications, the computer program product comprising:
a computer readable storage medium, and
computer readable program code embodied in the storage medium, wherein the computer readable program code is configured to:
receive keyboard event information corresponding to a plurality of keyboard events detected at a computer, wherein the keyboard events represent input to a computer software application;
determine that a number of paste actions indicated by the keyboard event information equals or exceeds a predefined threshold; and
perform a computer-security-related action responsive to determining that the number of paste actions equals or exceeds the predefined threshold, wherein the computer-security-related action relates to the computer software application.

17. The computer program product of claim 16 wherein the computer readable program code is configured to provide executable computer software instructions to the computer, wherein the executable computer software instructions are configured to:
monitor the keyboard events detected at the computer; and
report the keyboard event information associated with the keyboard events.

18. The computer program product of claim 17 wherein the computer readable program code is configured to provide the executable computer software instructions within a web page.

19. The computer program product of claim 16 wherein the predefined threshold is associated with the computer software application.

20. The computer program product of claim 16 wherein the computer readable program code is configured to determine the number of paste actions from the keyboard event information.
